(19) United States
(12) Patent Application Publication
(10) Pub. No.: US 2022/0371884 A1
(43) Pub. Date: Nov. 24, 2022

(54) HYDROTHERMAL PROCESS FOR PRODUCING HYDROGEN

(71) Applicants: Eric I. Schraud, Gordonville, PA (US); Huynh Dong Nguyen, Lancaster, PA (US); Matthew Schraud, Adamstown, PA (US)

(72) Inventors: Eric I. Schraud, Gordonville, PA (US); Huynh Dong Nguyen, Lancaster, PA (US); Matthew Schraud, Adamstown, PA (US)

(21) Appl. No.: 17/749,995

(22) Filed: May 20, 2022

Related U.S. Application Data
(60) Provisional application No. 63/231,579, filed on Aug. 10, 2021.
(60) Provisional application No. 63/191,298, filed on May 20, 2021.

(51) Int. Cl. C01B 3/10

(52) U.S. Cl. CPC C01B 3/10; C01B 2203/84; C01B 2203/1638

(57) ABSTRACT

Systems and methods for generating hydrogen from water consisting of reacting aluminum alloy powders with steam in the presence of an effective amount of promotor are provided. Aluminum powder is premixed with a dry solid-state promotor mixture before being exposed to high-temperature steam. Steam is introduced into a vessel called reactor, where the aluminum powder premixed with optimal ratio of promotors is contacted at pressure and temperature conditions to help the reaction between aluminum powder and water occurs completely, with 100% conversion in less than 15 minutes. Since the reaction occurs at high temperature condition, the heat released from the exothermic reaction between aluminum and steam is a “high-quality” heat, contributing to excess heat separation and making the most of the reaction heat, producing steam.

### CROSS-REFERENCE TO RELATED APPLICATIONS

This application claims the benefit of priority to U.S. Provisional Application No. 63/231,579 filed Aug. 10, 2021 and U.S. Provisional Application No. 63/191,298 filed May 20, 2021, the entireties of which are incorporated herein by reference.

### BACKGROUND OF THE INVENTION

The current invention relates to a method for producing high-purity hydrogen gas from aluminum powder, steam and promotor and a reactor system for carrying out the method.

It is well-know that under certain conditions, aluminum reacts with water to generate hydrogen gas and heat. It is also known, however, that this reaction is not “sustainable” at ambient conditions. This is at least partly due to a protective oxide layer that forms on aluminum surfaces in contact with water which hampers the reaction. Therefore, the protective oxide layer on the aluminum metal must be removed continuously and efficiently at elevated temperatures.

Many forms of hydrogen production exist, including reactive series metals and water reacting vigorously to produce hydrogen gas. The primary benefit of such methods is the ubiquitous nature of metals such as aluminum, or derivative alloys, and the ease of long-term storage and shipment versus alternate methods such as hydrogen compression, liquefaction, and shipment directly. The convenience of a solid fuel for on demand hydrogen and thermal energy production is an objectively more economical solution when compared with other methods. However, the rapid formation of a cohesion passivation layer, or oxide layer, which blocks and inhibits the material from continuing to react has been a hurdle to economic viability. The excising of this layer has historically proven difficult, corrosive to the vessel and reactor system, and not economically viable.

Traditionally these reactions are done only at the lab scale, at ambient conditions, and in a batch manner. Improving the thermodynamic conditions that the chemical reaction takes place under, such as high temperature and pressure, has shown to increase the energy output of the exothermic reaction by 5-10%, measured by a per mole of hydrogen produced basis. These conditions not only improve the reaction by providing some activation energy needed and thus offsetting the necessity for significant amounts or high concentrations of a base or acidic promoter and leading to corrosion of the reactor vessel itself, but they also allow for higher energy output and more efficiency latent heat exchange. The present invention addresses these concerns allowing for scaling of a solid fuel solution for thermal and hydrogen energy production.

The present invention is advantageous for efficiently extracting available energy from the exothermic reaction between aluminum powder and steam; and for simultaneously producing a high purity basic oxide metal which can be reused for manufacturing new elemental aluminum. The utility of the process and equipment of the current invention have applications in residential and commercial settings. Processes and reactor systems of the current invention will find advantageous applications in industries such as renewable energy plants, hydrogen or electric re-fueling stations, thermal power plants, or industrial gas processing plants. The process and equipment according to the current invention are practical, safe, scalable for use by residential or industrial users to generate hydrogen gas, heat and power. Furthermore, the process and equipment according to the current invention uses either post consumed aluminum waste readily available in domestic garbage and metal working shops, to promote recycling and energy conservation, or elemental new aluminum produced directly.

### SUMMARY OF THE INVENTION

In accordance with the present invention, methods are provided in which hydrogen gas is produced by reacting a reactant such as aluminum powder with steam in the presence of a unique promotor system. This produces large quantities of “high quality” heat, high purity hydrogen gas, and high value co-products. Processes of the present invention comprise continuously filling a reactor containing aluminum powder mixed with promotor with steam under regulated pressure. In some embodiments, the reaction runs to completion in approximate 15 minutes. In preferred embodiments of the invention the reactor uses steam and aluminum powder as fuel, and dual promotors to reduce the formation of oxide layers on the aluminum particles. The dual-promotor mixture is premixed with a fixed ratio (by weight) in a sufficient amount to ensure complete reaction of the aluminum powders with steam inside the reactor. The process also comprises the steps of drawing off co-product from the reactor.

In one embodiment of the present invention, a method for producing hydrogen gas includes reacting aluminum powder with steam in the presence of a dual promotor. The dual promotor may comprise sodium hydroxide and sodium aluminate, wherein the sodium hydroxide and the sodium aluminate amount to between 10% and 30% by weight of the aluminum powder. The ratio of the sodium hydroxide to the sodium aluminate is between 1:2 to 1:3.

An objective of the present invention is to provide a cost effective system for generating hydrogen as a renewable resource, competing with renewable energy sources such as solar and wind.

An advantage of the present invention is the use of reactant methods for the generation of hydrogen that do not result in corrosive or costly materials.

Additional objects, advantages, and novel features of the solutions provided herein will be recognized by those skilled in the art based on the following detail description and claims, as well as the accompanying drawings, and/or may be learned by production or operation of the examples provided herein.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic of core components of the current reactor system.

FIG. 2 is a detail of control philosophy of the current rector system.

FIG. 3 is a graphical representation of the reactor temperature versus operation time.

FIG. 4 is a graphical representation of the contacted surface area versus hydrogen production rate.

FIG. 5 is a graphical representation of the temperature versus hydrogen production rate.

FIG. 6 is a graphical representation of the promotors concentration versus hydrogen production rate.

FIG. 7 is a graphical representation of the reactant and promotors mixing time versus hydrogen production rate.

### DETAILED DESCRIPTION OF THE INVENTION

In accordance with the present invention, methods are provided in which hydrogen gas is produced by reacting a reactant such as aluminum powder with steam in the presence of a unique promotor system. This produces large quantities of “high quality” heat, high purity hydrogen gas, and high value co-products. Processes of the present invention comprise continuously filling a reactor containing aluminum powder mixed with promotor with steam under regulated pressure. In some embodiments, the reaction runs to completion in approximate 15 minutes. In preferred embodiments of the invention the reactor uses steam and aluminum powder as fuel, and dual promotors to reduce the formation of oxide layers on the aluminum particles. The dual-promotor mixture is premixed with a fixed ratio (by weight) in a sufficient amount to ensure complete reaction of the aluminum powders with steam inside the reactor. The process also comprises the steps of drawing off co-product from the reactor.

Hydrogen production efficiency and purity is measured through well-established methods in the scientific community. Hydrogen produced per unit mass of aluminum is about 1.243 to 1.3 liters per gram of aluminum. Hydrogen produced is run through a shell and tube heat exchanger to be cooled to ambient temperature (70F) and remove condensate. From there, the hydrogen is moved to a water tank, used traditionally in the scientific community, where the water displaced by the hydrogen is measured by volume in order to measure the hydrogen produced. Volumetric properties of hydrogen have been well established under specific temperature and pressure conditions. At ambient conditions the water displaced accurately measures hydrogen production by volume. Hydrogen production efficiency of the hydrogen generation system 100 described herein has measured consistently between 95% and 105%, falling over the 100% mark primarily because the promoters themselves both contain a hydrogen atom and will interact with each other to produce hydrogen. Additionally, these promoters will also interact with alumina in different phases in under certain operating conditions and in the presence of water. The dual promoter solution interacts with AlOH, AlOOH, and AlO thus continuing to produce hydrogen through the phase change of aluminum. Thus in some cases producing 105% of hydrogen when compared to the mass of aluminum alloy only. In some embodiments, the hydrogen generation systems and methods disclosed herein can achieve at least 90% total heat recovery efficiency of this excess energy released and subsequently use it to drive at minimum of 35 kW for every kg of hydrogen produced.

Hydrogen purity is measured by two methods. Observationally hydrogen purity is empirically recorded by burning the hydrogen and observing the color as to which the flame burns. Pure hydrogen burns complete clear and is invisible to the eye, while contaminated hydrogen will burn orange, blue, green, or a combination of these. To verify the purity of hydrogen achieved, instrumentation such as a hydrogen parts per million (ppm) meter is employed. The hydrogen ppm meter measures the concentration of hydrogen gas produced, verifying the high purity production of the hydrogen generation system 100 described herein of over 99.99%, accurate to 2 significant figure.

### Reactant

In preferred embodiments of the present invention, a reactant is provided. Reactant metals such as aluminum, potassium, sodium, calcium, magnesium, zinc, and iron and derivative alloys thereof may be used in methods of the present invention. In preferred embodiments of the invention, aluminum or derivative alloys thereof are used for processes of the present invention.

In other embodiments, the primary reactant may be comprised of a blend of oxidized ionic elements such as aluminum, magnesium, and manganese. Aluminum interacts with water, allowing the 3+ charge of the aluminum and the −1 on the OH to attract and balance to form aluminum hydroxide (AlOH) and hydrogen (H₂). Manganese has several oxidative states, with its most stable state being 2+, and magnesium has a charge of 2+. Manganese and magnesium react similarly, although magnesium requires an endothermic reaction for the reaction to be timely but will still interact with water.

Al+H₂O→Al(OH)₃+H₂

Mn+H₂O→Mn(OH)₂+H₂

Mg+H₂O→Mg(OH)₂+H₂

Sodium hydroxide (NaOH) deoxidizes these metals as in the reactant priming process. The 1+ charge on the sodium bonds with Al and O₂, balancing the charge and releasing the hydrogen. While deoxidation in useful concentrations is very caustic to humans and corrosive to reactor systems, the addition of sodium stannate greatly reduces the high concentration requirement. The presence of sodium stannate reduces the required concentration of sodium hydroxide, therefore reducing the caustic and corrosiveness of the system.

Stannate also forms a mechanical layer around Al, Mn, and Mg that defers the cohesion of a OH (Hydroxide) passivation layer, allowing for repeated interactions with H₂O. Tin (Sn) plays a mechanochemical role in the deference of hydroxide layers by coating the Al and forming a stronger positive charge that is strong enough to defer the anion OH. This mechanochemical layer reduces the amount of NaOH needed. In combination with the de-oxidative process of NaOH, aluminum is free to continue to react with H₂O and substantially increase efficiency.

In one embodiment, providing the reactants of Al:Mg:Mn:SnOH:Na₂SnO₃ at a ratio of 1:0.01:0.008:0.2:0.1 plays a significant role in the rapid release of potential energy in this exothermic reaction. The rapid kinetic energy transfer causes temperature to rise above 212 degrees F., promoting the formation of steam. The reactants and optional promoters interact with H₂O as a gas in a favorable manner, only oxidizing the metals instead of forming hydroxides. Sodium stannate plays a dual role: the sodium reduces the intermolecular bond strength between dihydrogen and oxygen, in turn improving the conductivity of water by reducing covalent bond strength and therefore the energy needed to break those bonds. Tin (Sn) is freed during this process and plays a mechanochemical role, developing an ionic barrier the larger reactant metals. This process disrupts the adherence of OH (hydroxides) and allows reactant metals to continue to interact with H₂O. As a result, much less reactant is needed to process more over a shorter period of time. The efficiency gain is 15× that of previous Al+NaOH methods, therefore reducing the amount of reactants needed by 15×.

For any selected reactant, the surface area of the reactant may be optimized to minimize the need for agents to excavate the cohesion passivation layer. One skilled in the art would appreciate methods of optimizing surface area. For instance, the reactant can be milled, gas atomized or screened to provide a specific particle size distribution (PDS) of from about 30 to about 125 microns, and more specifically from about 45 to about 100 microns. In still other embodiments of the present invention the PDS of reactant is from about 50 to about 80 microns or from about 65 to 75 microns. In still other embodiments, the PDS of the reactant includes sizes greater than 100 microns, for example, up to and greater than 1 mm in size. In some preferred embodiments the reactant is in the form of a powder comprising particles having an optimized surface area such as, but not limited to spherical, platelet, or fibrous particles.

### Promoter

In some embodiments, the promoter is comprised of a mixture of a strong base and an alkali metal aluminate and lowers the activation energy of reactions. While a base or an aluminate can be used alone, a mixture of two promoters reduces corrosion issues and salt scaling on reactor walls. In particular, the combination of the two promoters contributes to reduce the production cost and increase the economic feasibility.

The dual promotor may comprise sodium hydroxide and sodium aluminate. In one embodiment, the sodium hydroxide and the sodium aluminate amount to between about 10% and about 30%, preferably less than 15%, by weight of the reactant. For example, the mass mixing ratio of aluminum reactant to sodium hydroxide to sodium aluminate is 20:1:2. In another embodiment, a ratio of sodium hydroxide to sodium aluminate may range between about 1:2 to about 1:3.

Thermodynamic activation variables such as pressure and temperature may be adjusted to optimize a reaction system. For instance, high temperature and pressure will reduce the amount of promoter required. While the reaction can proceed at ambient temperature, increased temperature and/or pressure provides faster reaction times and lowers the quantity of promoter required.

In other embodiments, alternative and/or additional promotors may be used.

### Temperature

In some aspects of the invention, promoter is mixed with reactant in a vessel in the presence of H₂O, preferably in a vapor form such as steam. The reaction may proceed at ambient temperatures but more preferably at temperatures ranging from 140 degrees C. to 600 degrees C., more preferably about 200 degrees C. to 550 degrees C.

In some embodiments, the aluminum powder and H₂O reaction in the presence of the dual promotor is initiated at temperature of about 50 degrees Celsius. In this embodiment, the H₂O may be provided in liquid form.

### Pressure

Methods of the invention are advantageous for providing the ability to control the intensity of the reaction between steam and reactant such as aluminum powder in response to the pressure and/or temperature generated inside the reactor by the exothermic reaction. In some preferred embodiments, the pressure within the reactor is maintained at a pressure of 290 psi (20 bar) to 2400 psi. In some embodiments, a pressure of 1500 psi is maintained.

Pressure within the reaction vessel can be modulated by methods known to those skilled in the art. For instance, pressure can be modulated by controlling the flow of steam and/or the flow of reactants into the reactor vessel. Pressure is controlled by modulating the steam injected, for example with a control valve, as well as controlling the input of reactant. In other aspects of the invention pressure as well as proper mixing within the reactor can also be modulated by controlling how much and/or quickly hydrogen exits the reactor in addition to controlling the steam and/or reactant flow into the reactor. A reduction in volume of reactants for interaction with steam limits the ability for hydrogen to be produces. In some cases more steam may be injected simply for the exchange of heat energy already present in the system which is then used for commercial purposes, additionally it controls the temperature and pressure of the system. The output or evacuation of hydrogen from the reactor may also be modulated in order to control pressure and ensure maximum steam dispersion within the reactor. The equipment may also have means for raising and lowering the pressure and temperature of the reactor such as in response to more or less aluminum powder flowing into the reactor.

Mixing efficiency of aluminum powder and promoter may impact the yield of the reaction. In preferred embodiments of the invention, surface contact between the aluminum powder and steam is optimized.

### Thermal Energy

Preferably, thermal energy may be extracted by direct low pressure steam injection that oversaturates the reactor, i.e., in excess of H₂O consumed in the reaction. Thermal energy extracted in the form of high pressure and high temperature steam and hydrogen are produced simultaneously and may be used to drive energy intensive processes accordingly.

For instance, thermal energy in the form of high temperature and high pressure may be used to drive industrial heat processes of all kinds and may, for instance, take the place of natural gas for pure BTU driven heat intensive processes such as curing, annealing, jet milling, or building heat. Additionally, the thermal energy can be used to drive a steam turbine and generate electricity for commercial, industrial, or grid use. In some aspects of the invention, low pressure steam at the outlet of a turbine may be run through a waste heat recovery system (WHRS) in the Rankin cycle and used to drive lower intensity BTU processes, motors, or provide building heating.

Green electricity derived from thermal energy generated by the exothermic reaction of this chemical process is a new and unique process.

The latent heat produced by the exothermic reaction typically has a low heat exchange efficiency, due to the ambient conditions these reactions have historically been facilitated under. The high-temperature and high-pressure conditions improved the latent heat recover by 50-70%, with an overall exchange efficiency up to 90% heat recovery. The high heat recovery increases the overall energy output of the system for use in industrial heat intensive processes or for steam driven electrification significantly. Higher energy production and extraction from the same inputs (due to efficiency gains) greatly improves the techno-economics of the solution, to the point where green energy from this system is economically viable today. Thus, in accordance with the invention water is contacted with reactant to produce hydrogen gas, exothermic energy, and co-products. At large scales, the reaction can run to completion in as little as about 15 minutes.

### Reactor

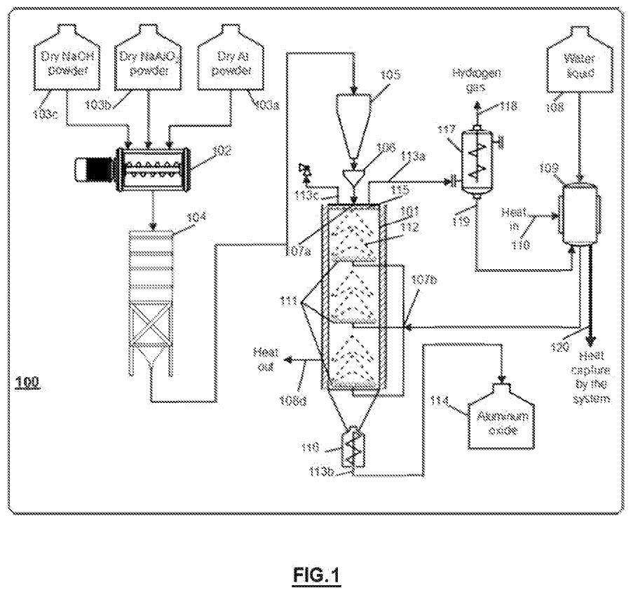

The hydrogen gas production according to the current invention is obtained by a reaction of reactant metal powder, such as aluminum powder, with steam in the presence of promotor as illustrated in FIG. 1. The chemical reaction produces a large amount of heat, hydrogen gas, and valuable co-product; the heat released by the system could be captured as “high-quality” heat source which be used to generate power. The reactor vessel housing the reaction may be fed by two systems, a steam drum, and a reactant feeder system.

In general, the steam drum may be heated externally during the ramp up period, after which the steam drum may be fed by low pressure steam circulating back from recovered waste heat. For instance, produced hydrogen may flows through kettle reboilers or plate heat exchangers to cool the hydrogen and recover heat. This recovered heat may be used to produce steam which is fed into the steam drum system. Another method of heat recovery is capturing low pressure steam from an outlet of a steam turbine whereby, in accordance with the Rankin cycle principal, steam may be recovered and either sent through the hydrogen heat recovery system for further heating or sent directly to the steam drums to be fed back into the reactor. This process utilizes the exothermic energy produced as its own source of energy for maintaining operating conditions, negating the need for an external energy input. Effectively, the energy input is in the form of a solid fuel (the reactant) and generated chemically. When using self-generated heat, roughly about 9% of the exothermic energy released is consumed to maintain operating conditions in the heat mass balance equation.

FIG. 1 depicts an example embodiment of a hydrothermal system 100 of the present invention for producing hydrogen gas. The system 100 possesses a chemical reactor that receives mixture of aluminum powder, dry dual-promotor from a top inlet, and steam from a bottom inlet, and outputs hydrogen from the top of the reactor, a co-product slurry from the bottom of the reactor, and heat released by the chemical reaction.

Referring to FIG. 1, the reactor system 100 includes a thermal insulation reactor 101, a rotary powder mixing drum 102 to mix aluminum powder 103a, dry promotor NaAlO₂ 103b, and dry promotor NaOH 103c. An intermediate hopper 104 provides dry powder reactants to the solid powder feeder system 105. The flow of dry powder reactants is quantified by the meter 106 before prior to reaching the reactor 101 via a first inlet 107a. A liquid water source 108 is heated in the steam drum 109 where the initial heat 110 is supplied during the starting up period of the system to convert liquid water into saturated steam inside of steam drum 109, and then pressurized steam source that provides water reactant into the reactor 101 via a second inlet 107b from the bottom and side of the reactor; this flow also supplies enough extra quantity of water to absorb the heat released by the exothermic reaction inside of the reactor. In order to ensure the “phase contact” inside of the reactor 101, steam distributor system 111 is used to spray steam flow up through the solid powder layers, distributed on one or more sieve trays 112.

The generated hydrogen outputs from a first outlet 113a, and a co-product slurry is pumped out of a second outlet 113b to an aluminum oxide vessel 114. Solid powder pulled with hydrogen gas 113a is firstly separated and retained inside of the reactor by a mesh filter 115 installed on the top of reactor 101, while a specific design high pressure screw conveyor 116 to draw off the slurry solid from the bottom of reactor. A safety valve is connected to the third outlet of the reactor 113c to protect the system from over pressure.

The mass mixing ratio of dry powders as follow: 100 Aluminum:5 NaOH:10 NaAlO₂, which represents the practical maximum ratio to 400 H₂O at 180 degrees C. and 450 psig condition. A higher ratio of NaOH to NaAlO₂ or a solution of dual promotor mixture in water can be used but doing so would become impractical due to corrosion issue, particularly at higher temperature condition; while crystallization of a significant quantity of NaOH and NaAlO₂ would occur at lower temperature, which would be undesirable or impractical for scaling up purpose.

The hydrogen generation system 100 may also produce a co-product slurry such as boehmite and/or alumina. The hydrothermal and chemical process for producing primarily dehydrated alumina, namely boehmite and aluminum oxide (AlOOH and AlO), was achieved under a smaller range of the operating conditions of the reactor. Maintaining a temperature of 300 degrees C. to 550 degrees C. and a pressure of 100 PSI provides conditions sufficient for aluminum to change phase. Temperature conditions under this range predominately produce a hydrated form of alumina such as aluminum hydroxide (AlOH) and/or a small amount of aluminum oxide hydroxide (AlOOH). The temperature and pressure conditions noted above may be modified to create different conditions for generating a co-product slurry including boehmite and/or alumina, for example. The excision of the oxide layer for fully particle conversion is still needed to produce an alumina in any phase. For this reason the hydrothermal process accompanied by a hydroxide promoter solution, such as our dual promoter solution, is needed.

Heat 108d produced by the exothermic chemical reaction does not simply help enhance the chemical reaction rate and reduce the reaction time, but it can also be captured by extra water flow rate provided into the reactor 101 via the extra steam 107b. The heat released by the exothermic chemical reaction is absorbed and converted into steam energy flow and flows out the reactor 101 together with the hydrogen gas 113a. The hydrogen gas from 113a is next separated from steam by a specific filter-centrifugal-membrane separator 117. The separator 117 splits the hydrogen gas stream 113a into pure hydrogen gas 118, which is further purified and dried by adsorption process (not shown) before sending to storage, while the captured steam 119 provides extra steam flow to steam drum 109. This steam 119 provides enough water quantity to maintain the operation of reactor 101, also supply extra steam flow captured from the system 120 and supply energy for further purposes.

The configuration of the hydrothermal system 100 allows the combining of the three dry powder as reactants, aluminum and dual promotors, and water is supplied into the reactor 101 in a vapor phase as steam. Various types of well-known mechanisms may be used within the reactor 101 as necessary to mix the reactants and continuously feed the reactants into the reactor 101. For example, in one approach, all reactants are premixed with liquid water and fed to the reactor 101 one at a time to cause the chemical reaction. However, the reaction time of this process takes more than 30 minutes to complete and the conversion is not fully completed. In another approach, the dry reactants can be initially provided to the reactor 101 and then the steam is pressurized later, where the rate of introduction of the steam into the reactor is determined by the weight of aluminum powder. This approach accelerates the reaction rate and helps to reach a full conversion in less than 15 minutes. However, one of the most important factors that affect to the reaction rate and conversion is phase contact issue. In some embodiments, the reactor may include additional components such as one or more sieves or trays to provide sufficient phase contact.

As will be appreciated, pressure gauges and sensors, temperature gauges and sensors, or both may also be installed allowing a communication and control the system operation. These instrumentations enable operators to visually monitor the development of exothermic reaction occurring inside the reactor. The process and equipment according to the current invention are practical and safe for industrial scale up purpose to produce hydrogen gas and furthermore, the method also use aluminum waste readily available in domestic garbage and metal working shops, to promote recycling and energy conservation. This process is advantageous for extracting available energy from an exothermic chemical reaction between aluminum waste and steam, this also for simultaneously producing a basic metal which can be reused for manufacturing new aluminum.

The reactor's pressure is maintained by a pressure control system which regulates the effluent flow out of the reactor to the steam separator system 117. The heat released from chemical reactions will be carried out of the reactor via steam's energy, this energy will be captured by a steam separator 117 at the downstream of the process and allow to supply high quality steam serving for steam turbines or similar equipment for power generation purposes 120.

Several series of experiments were implemented to measure the volume of hydrogen gas released in a typical reaction. In these experiments, aluminum powder having a 74-micron average size was placed in a 160 ml pressure cell. The volume of water displaced by the gas produced from the pressure cell was measured and corrected to a gas volume at standard temperature and pressure. Atmospheric pressure on that day was recorded from an in-house equipment. The corrected volume of gas produced was compared to the theoretical quantity of hydrogen gas, which would be obtained according to the equation:

Al+H₂O→Al(OH)₃+H₂

These experiments were implemented in a reactor maintaining a temperature of 140° C. to 180° C. and a saturated pressure of steam at corresponding temperature. In all cases, the reaction start was detected by an increasing of pressure in the pressure cell. The reaction started right after steam contacted with dry powders and continued for few minutes, until depletion of the reactant powders. A typical reaction with less than 15 minutes is considered as favorable. The results of these experiments are shown in Table 1 below.

TABLE 1
Hydrogen gas production from aluminum powder,
74-micron average size

| | | | | | | H₂ | |
|---|---|---|---|---|---|---|---|
| Exp. | Al | NaOH | NaAlO₂ | Promotor | H₂ STP | theoretical | Yield |
| # | (g) | (g) | (8) | (%) | (1) | (1) | (%) |
| 1 | 2 | | 0.3 | 15.0% | 2.04 | 2.49 | 81.9% |
| 2 | 2 | | 0.3 | 15.0% | 2.1 | 2.49 | 84.3% |
| 3 | 2 | | 0.3 | 15.0% | 2.06 | 2.49 | 82.7% |
| 4 | 2 | | 0.3 | 15.0% | 2.03 | 2.49 | 81.5% |
| 5 | 2 | | 0.3 | 15.0% | 2.09 | 2.49 | 83.9% |
| Avg. | 2 | | 0.3 | 15.0% | 2.06 | 2.49 | 82.9% |
| 11 | 2 | | 0.44 | 22.0% | 2.63 | 2.49 | 105.6% |
| 12 | 2 | | 0.44 | 22.0% | 2.6 | 2.49 | 104.4% |
| 13 | 2 | | 0.44 | 22.0% | 2.59 | 2.49 | 104.0% |
| 14 | 2 | | 0.44 | 22.0% | 2.61 | 2.49 | 104.8% |
| 15 | 2 | | 0.44 | 22.0% | 2.62 | 2.49 | 105.2% |
| Avg. | 2 | | 0.44 | 22.0% | 2.61 | 2.49 | 104.8% |
| 16 | 5 | | 1 | 20.0% | 6.53 | 6.217 | 105.0% |
| 17 | 5 | | 1 | 20.0% | 6.52 | 6.217 | 104.9% |
| 18 | 5 | | 1 | 20.0% | 6.49 | 6.217 | 104.4% |
| 19 | 5 | 0.2 | 0.7 | 18.0% | 6.51 | 6.217 | 104.7% |
| 20 | 5 | 0.2 | 0.7 | 18.0% | 6.55 | 6.217 | 105.4% |
| Avg. | 5 | 0.2 | 0.88 | 19.2% | 6.52 | 2.49 | 104.9% |

The results from Table 1 demonstrate that the reaction is reproducible and produces stoichiometric quantities of hydrogen gas. The average yield of hydrogen gas was 103%, which is considered to be within the measurement uncertainty. There are at least two factors which might have contributed to a slightly higher yield the theoretical hydrogen yield. First, it is possible that the cell was not a vacuum, which could increase the observed value for the volume of gas produced. At a maximum, this could have increased the measured volume by about 2%. Second, the water used was tap water and may have included dissolved air, which would have increased the volume of gas measured. These would have affected the results by less than 1%. Since the results are within the measurement error, and quantification of these sources of errors would not significantly affect the results, no further experiment was implemented.

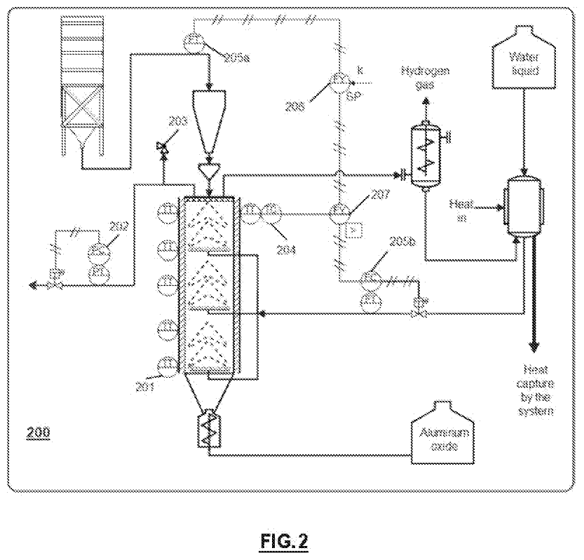

Turning now to FIG. 2, a hydrogen production control system 200 is shown. The control system 200 contains the same core elements as FIG. 1 but provides a basic view of control philosophy and some basic control relationships and interconnections between some key process parameters to ensure the system operate continuously and safely. On the side of reactor, there are some thermos sensors and gauges 201. The exothermic chemical reaction inside of the reactor causes an increase in temperature. Temperature sensors enable operators to visualize the temperature of the reactor and report to the operator about hydrogen production system. In an effort to stabilize and maintain the chemical reaction between aluminum and steam, temperature sensors also allow operators to minimize any excess temperature increases due to extra heat released from the system, which could damage the reactor materials. Reporting the temperature in such a manner alerts the operator to increase or decrease in temperature and to react accordingly if cooling or heating of the reactor is needed.

Like an increase in temperature, an increase in pressure occurs when chemical reaction takes in place within the reactor. To operate the reactor continuously and safely, a safety device such as safety valve or relief valve or a rupture disk (burst—not shown) device and a pressure controller is installed on the top of the reactor. This installation is provided to further improve the safety of the reactor and releases a pressure over unsafe level. The pressure gauge or controller reports to the operator the pressure within the reactor vessel. The pressure controller 202 is installed to regulate the effluent (hydrogen) flow and maintain the required pressure inside of the reactor, this allows the operator the opportunity to know when to release the hydrogen gas from the reactor, thereby lowering the pressure of the reactor for a proper and safer operation of the system. Both temperature and pressure signals could be used for an alarms purpose or connected to an emergency shutdown system (ESD) to shut down entire the system if the process parameters reach a critical value or are uncontrollable. To prevent any backflow of gas from high pressure section to lower pressure section at certain period of normal operation, check valve is preferred to install (not shown).

The control system 200 also includes a meter 206 for monitoring the quantity of aluminum powder and dual promotor therein and a solid powders flow sensor 205a to regulate the steam quantity 205b which is proportional to quantity of aluminum filled in the reactor (by setting a factor k, 206). A temperature controller 204 monitors the temperature of the reactor via regulating the flow of steam 205b supply to the reactor. For safety, a high selector 207 could be installed to ensure that the temperature of the reactor is the highest priority to be considered to maintain.

At the bottom of the reactor, a level controller also preferably installed through reactor's bottom surface (not shown) to facilitate the periodic removal of the co-products such as boehmite or alumina. A drainage output allows the slurry to be removed from the reactor via a drain valve (not shown). The drain flow is performed by a solid handling valve (not shown) to maintain the required slurry level inside of reactor and residence time of reacted slurry. Due to high temperature of slurry flow, this value co-product could be cool down before sending to storage (not shown) or pump directly to another reactor system to convert to alumina by the chemical reaction. The drain output has also another function within the hydrogen production system. As in the case of steam flow controller, the drainage output allows for the emergency evacuation of the slurry from the reactor bottom if the temperature and pressure reach a critical or uncontrollable level.

Also attached to the system a purge line (not shown). The purge line exists to remove air inside of the system before startup period. The purge line may connect to a vacuum pump, which creates a clean vacuum space and can later be filled with hydrogen gas when the chemical reaction occurs.

The reactor requires an energy input only during the first start up, or ramp up. Subsequent operating conditions, such as high temperature and high pressure, are maintained by the exothermic nature of the reaction and pressure by the production of hydrogen and expansion of steam. The initial energy input for ramp up can be, but is not limited to, provided through electric band headers around the reactor itself, or in a system around the steam drums, to heat and steam liquid water. Natural gas may also be used in a steam drum/boiler system to generate heat and steam. Aluminum, or alloy derivative, or reactive series metals with the dual promoter solution at ambient conditions may also be used to generate heat and steam. These methods are some of the ways to ramp the reactor up to operation conditions and the use of either is dependent on the project's needs.

As the reactor is fed with a continuous stream of aluminum, alloy derivative, or other reactive series metals, pre-blended with the dual promoter solution and H₂O (g) steam at operation conditions, the reaction will proceed continuously. The energy released during the reaction provides the heat needed to keep the reaction at a desired operating temperature, and is directly correlated to the volume of reactant (aluminum, alloy derivative, or reactive series metal) input. This pressure is directly correlated to the heat present, low pressure steam injected, and hydrogen produced. The hydrogen produced is directly correlated to the amount of reactant (aluminum, alloy derivative, or reactive series metal) oxidized in the process. All of these variables are controlled for to produce the desired conditions for the reactor.

With reference to FIG. 3, it will be appreciated that a typical operation period is known to have a starting up phase (C), during which the temperature of reactor and steam drum rises. A normal operation phase (S) during which the temperature inside of the reactor is preferably kept at ranging from 300° C. to 550° C., and a shutting down phase (D) to turn off the reactor. At an operation temperature during the normal operation phase (S) of about 300° C., the reaction has been found to be self-sustained and hydrogen gas produced contained steam from extra water flow supplied from the storage tank. The reactor temperature is maintained sufficiently high to ensure the reaction continuously occurs without any additional heat needed during the normal operation period. The starting up phase (C) can be shortened by introducing a fuel pellet inside the reactor. For example, the fuel pellet preferably contains very fine aluminum powders. The fine aluminum powders are known to be highly reactive with water or steam to generate a burst if heat which causes the reactor temperature to approach the working conditions quickly and accelerate a reaction. During the normal operation (S), according to the temperature and pressure of reactor, the aluminum powder is tuned and feed into the reactor.

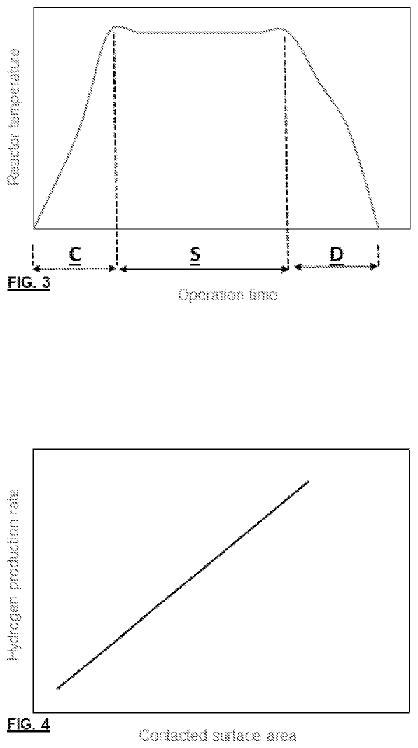

FIG. 4 shows a graphical representation of the hydrogen production rate within the hydrogen production system in relation to contacted surface area between steam and aluminum powder (vapor-solid phase contact). Dedicated testing and experimentation determined that contacted surface area is an important control factor regarding to the production rate of hydrogen and also the conversion of the reaction. It was found that the contacted surface area of the aluminum powder exposed to the steam has a linear relationship with the hydrogen production rate. Therefore, exposing more or less contacted surface area of aluminum and steam would either increase or decrease the production rate of hydrogen in the system.

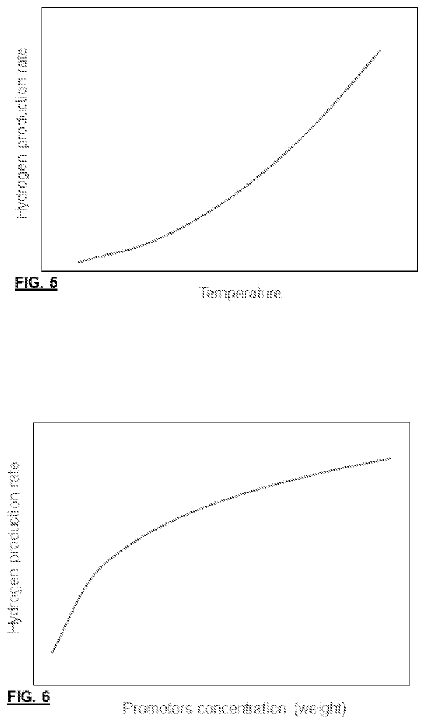

FIG. 5 shows a graphical representation of the hydrogen production rate within the hydrogen production system in relation to temperature. Dedicated testing and experimentation determined that the temperature obtained by the chemical reaction is an important control parameter regarding to the production rate and yield of hydrogen. It was found that as the temperature of the reactor increased, the production rate of hydrogen gas increased exponentially. Therefore, to regulate the production of hydrogen gas using the reactor system, the temperature of the reactor must be closely monitored and adjusted to maintain a steady constant production rate. Therefore, control mechanisms such as temperature gauge or temperature sensors with the extracting heat fluid have been added to the reactor system to safely control the production system. Uncontrol temperature of the reactor could lead to a catastrophic failure of the reactor.

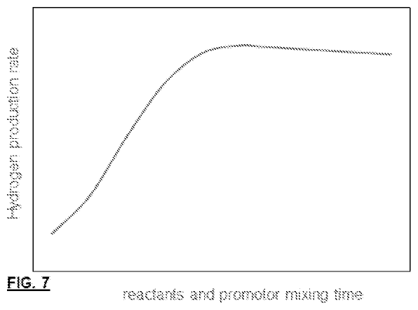

FIG. 6 shows a graphical representation of the hydrogen production rate within the hydrogen production reactor in relation to the promotors concentration. Dedicated testing and experimentation determined that the weight percentage of the dual promotors to aluminum weight is an important control parameter regarding the production rate and yield of hydrogen. This relationship between the production of hydrogen and the percentage of dual promotors was found to be logarithmic. Testing shown that production levels below a certain ratio were not consistent and self-sustaining. Therefore, for adequate and self-sustaining production of hydrogen using the reactor system, the operator should maintain a certain percentage of the dual promotors.

FIG. 7 shows a graphical representation of the hydrogen production rate within the reactor system in relation to the dry powder mixing time. Dedicated testing and experimentation determined that the mixing time of dry aluminum and dual promotors is an important control parameter regarding to the production rate and yield of hydrogen. It was found that the mixing time of dry aluminum powder and dual promotors should take longer than 5 minutes but no more than 15 minutes. If the mixing time is longer than 15 minutes, the aluminum powders start to react with moisture in the air and release heat, produce hydrogen gas, which is not a favorable situation during the reactant's preparation process. However, a full conversion of the reactant will not achievable if aluminum powder does not well mix with promotors.

Any of the reactive series metals may be employed in this method for the production of hydrogen and thermal energy. In some embodiments, a reactant may chosen primarily for technoeconomic reasons. Additionally, the dual promoters may be chose for technoeconomic reasons; however there are others that may be used. The primary element of a promoter solution is the need for a hydroxide base (OH), coupled with a reactive series metal such as sodium, aluminum, tin, magnesium, manganese, to name a few. Hydroxide promoters coupled with a reactive series metal make them ionic compounds and easily ionized. It was found that the ionization of H₂O, the weakening of the bonds to create a polar particle H+ and OH—, have a profound impact on electron movement and is the chemical mechanism to the oxidation and reduction process. Ionized promoters, as explained above, are key to enhancing the reaction and acting as one of several levers making up the thermodynamic activation energy required, such as promoter/catalyst, temperature, pressure, which are inversely related in-terms of minimum level or concentration needed. Other factors impact the rate and efficiency such as PDS mentioned in another section.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A method for producing hydrogen gas comprising:
reacting aluminum powder with steam in the presence of a dual promotor.

2. The method of claim 1, wherein said step of reacting of the aluminum powder and the steam is initiated at temperature of about 50 degrees Celsius.

3. The method of claim 1, wherein said step of reacting the aluminum powder with the steam occurs at a temperature greater than 140 degrees Celsius.

4. The method of claim 1, wherein said dual promotor comprises sodium hydroxide and sodium aluminate, wherein the sodium hydroxide and the sodium aluminate amount to between 10% and 30% by weight of the aluminum powder.

5. The method of claim 4, wherein the ratio of the sodium hydroxide to the sodium aluminate is between 1:2 to 1:3.

6. The method of claim 4, further comprising the step of producing boehmite and/or alumina.

7. The method of claim 1, further comprising the steps of:
generating hydrogen gas with a hydrogen production efficiency of at least 95%; and
generating a co-product slurry.

8. The method of claim 1, further comprising the step of generating hydrogen gas with a purity greater than 99%.

9. The method of claim 1, further comprising of the steps of:
generating hydrogen gas; and
generating thermal energy in quantity of heat higher than 122,000 Btu or 35 kWh for each kg of Hydrogen produced.

10. The method of claim 1, further comprising the step of providing a reactor, and wherein said step of reacting aluminum with steam in the presence of dual promotor is carried out in the reactor.

11. The method of claim 10, further comprising the step of providing a pressure system configured to control pressure within the reactor, wherein the pressure system maintains a maximum pressure after the first cycle of operation of up to 2400 psi.

12. The method of claim 10, further comprising the step of providing a flow control of the aluminum powder into the reactor and a proportional ratio control of a steam flow rate in response to a temperature and pressure inside said reactor.

13. The method of claim 1, wherein the aluminum powder and the dual promotor are provided as dried solid powders, and wherein the steam is provided in a vapor phase.

14. A method for producing hydrogen gas, heat, power, and high value of co-product, the method comprising the steps of:
premixing reacts including aluminum powder and dried dual promotor;
dispensing the reactants into a reactor;
feeding steam into the reactor; and
controlling the reactants dispensed into the reactor in order to control a temperature and pressure within the reactor.

15. A hydrogen generation system for producing hydrogen gas, valuable co-product, heat and power, the hydrogen generation system comprising:
a main high pressure high temperature reactor;
a feeder system connected to the reactor to supply aluminum powder and dual-promotor;
a steam distributor system connected to the reactor;
a slurry control system to draw off co-product from reactor;
a control system configured to maintain a temperature and a pressure inside of the reactor; and
a steam separation system.

16. The hydrogen generation system of claim 15, further comprising a pressure safety regulating system.
